(19) United States
(12) Patent Application Publication
(10) Pub. No.: US 2011/0179383 A1
(43) Pub. Date: Jul. 21, 2011

(54) METHODS, SYSTEMS, AND COMPUTER PROGRAM PRODUCTS FOR AUTOMATICALLY SELECTING OBJECTS IN A PLURALITY OF OBJECTS

(76) Inventor: Robert Paul Morris, Raleigh, NC (US)

(21) Appl. No.: 12/689,169

(22) Filed: Jan. 18, 2010

(51) Int. Cl. G06F 3/048

(52) U.S. Cl. 715/790

(57) ABSTRACT

Methods and systems are described for automatically selecting objects in a plurality of objects. In one aspect, a method and system receives, based on a user input detected by an input device, an iterate indicator for automatically iterating through a plurality of objects; determines a target application, wherein the target application is configured to present the plurality of objects on a display device; and in response to receiving the iterate indicator, instructs the target application to automatically present sequentially in time each object, in the plurality, as selected.

### RELATED APPLICATIONS

This application is related to the following commonly owned U.S. patent applications, the entire disclosure of each being incorporated by reference herein: application Ser. No. 12/688,996 (Docket No 0073) filed on Oct. 18, 2010, entitled “Methods, Systems, and Program Products for Traversing Nodes in a Path on a Display Device”; and

Application Ser. No. ______ (Attorney Docket No 0093) filed on ______, entitled “Methods, Systems, and Program Products for Automatically Selecting Objects in a Plurality of Objects”.

### BACKGROUND

Graphical user interfaces (GUIs) have changed the way users interact with electronic devices. In particular, GUIs have made locating and performing commands or operations on many records, files, and other data objects much easier. For example, users can use point and click interfaces to select a documents, press a delete key to delete a file, and a right click a mouse button to access other commands. To operate on multiple data objects, such as files in file folders, a user can press the <ctrl> key or <shift> key while clicking on multiple files to create a selection of more than one file. The user can then operate on all of the selected files via a context menu activated by a right-click, a “drag and drop” with a pointing device to copy, move, and/or delete the files, and, of course, a delete key press to delete the files.

Prior to GUI's a user had to know the names of numerous operations and had to know how to use matching expressions including wildcard characters to perform an operation on a group of data objects.

Despite the fact the electronic devices have automated many user tasks; locating and performing commands on one or more program and/or data objects remains a task requiring users to repeatedly provide input to select objects and select operations. This can not only be tedious for some users, it can lead to health problems as reports of the incidence of repetitive motion disorders indicate. Press and hold operations are particularly unhealthy when repeated often over extended periods of time.

Selecting and operating on multiple objects presented on a GUI remains user input intensive and repetitive. Accordingly, there exists a need for methods, systems, and computer program products for automatically selecting objects in a plurality of objects.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Methods and systems are described for automatically selecting objects in a plurality of objects. In one aspect the method includes, receiving, based on a user input detected by an input device, an iterate indicator for automatically iterating through a plurality of objects. The method further includes determining a target application, wherein the target application is configured to present a plurality of objects on a display device. The method still further includes, in response to receiving the iterate indicator, instructing the target application to automatically: present, on the display device, a first object, in the plurality, as selected; update the display device to indicate the first object is not selected after presenting the first object as selected; and present on the display device, subsequent to presenting the first object as selected, a second object, in the plurality as selected.

Further, a system for automatically selecting objects in a plurality of objects is described. The system includes an execution environment including an instruction processing machine configured to process an instruction included in at least one of an input router component, an application manager component, and an iterator component. The system includes the input router component configured for receiving, based on a user input detected by an input device, an iterate indicator for automatically iterating through a plurality of objects. The system further includes the application manager component configured. for determining a target application, wherein the target application is configured to present a plurality of objects on a display device. The system still further includes the iterator component configured for in response to receiving the iterate indicator, instructing the target application to automatically: present, on the display device, a first object, in the plurality, as selected; update the display device to indicate the first object is not selected after presenting the first object as selected; and present on the display device, subsequent to presenting the first object as selected, a second object, in the plurality as selected.

In another aspect, a method for automatically selecting objects in a plurality of objects is described that includes receiving, based on a user input detected by an input device, an iterate indicator for automatically iterating through a plurality of objects. The method further includes determining a target application, wherein the target application is configured to present the plurality of objects on a display device. The method still further includes in response to receiving the iterate indicator, instructing the target application to automatically present sequentially in time each object, in the plurality, as selected.

Still further, a system for automatically selecting objects in a plurality of objects is described. The system includes an execution environment including an instruction processing machine configured to process an instruction included in at least one of an input router component, a application manager component, and an iterator component. The system includes the input router component configured for receiving, based on a user input detected by an input device, an iterate indicator for automatically iterating through a plurality of objects is described. The system also includes the application manager component configured for determining a target application, wherein the target application is configured to present the plurality of objects on a display device. The system still further includes the iterator component configured for in response to receiving the iterate indicator, instructing the target application to automatically present sequentially in time each object, in the plurality, as selected.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a block diagram illustrating an exemplary hardware device included in and/or otherwise providing an execution environment in which the subject matter may be implemented;

FIG. 2 is a flow diagram illustrating a method for automatically selecting objects in a plurality of objects according to an aspect of the subject matter described herein;

FIG. 3 is a block a diagram illustrating an arrangement of components for automatically selecting objects in a plurality of objects according to another aspect of the subject matter described herein;

FIG. 4 is a block a diagram illustrating an arrangement of components for automatically selecting objects in a plurality of objects according to another aspect of the subject matter described herein;

FIG. 5 is a block a diagram illustrating an arrangement of components for automatically selecting objects in a plurality of objects according to still another aspect of the subject matter described herein;

FIG. 6 is a network diagram illustrating an exemplary system for automatically selecting objects in a plurality of objects according to an aspect of the subject matter described herein;

FIG. 7 is a diagram illustrating a user interface presented by a display according to an aspect of the subject matter described herein; and

FIG. 8 is a flow diagram illustrating a method for automatically selecting objects in a plurality of objects according to an aspect of the subject matter described herein.

### DETAILED DESCRIPTION

Prior to describing the subject matter in detail, an exemplary device included in an execution environment that may be configured according to the subject matter is described. An execution environment is a configuration of hardware and, optionally, software that may be further configured to include an arrangement of components for performing a method of the subject matter described herein.

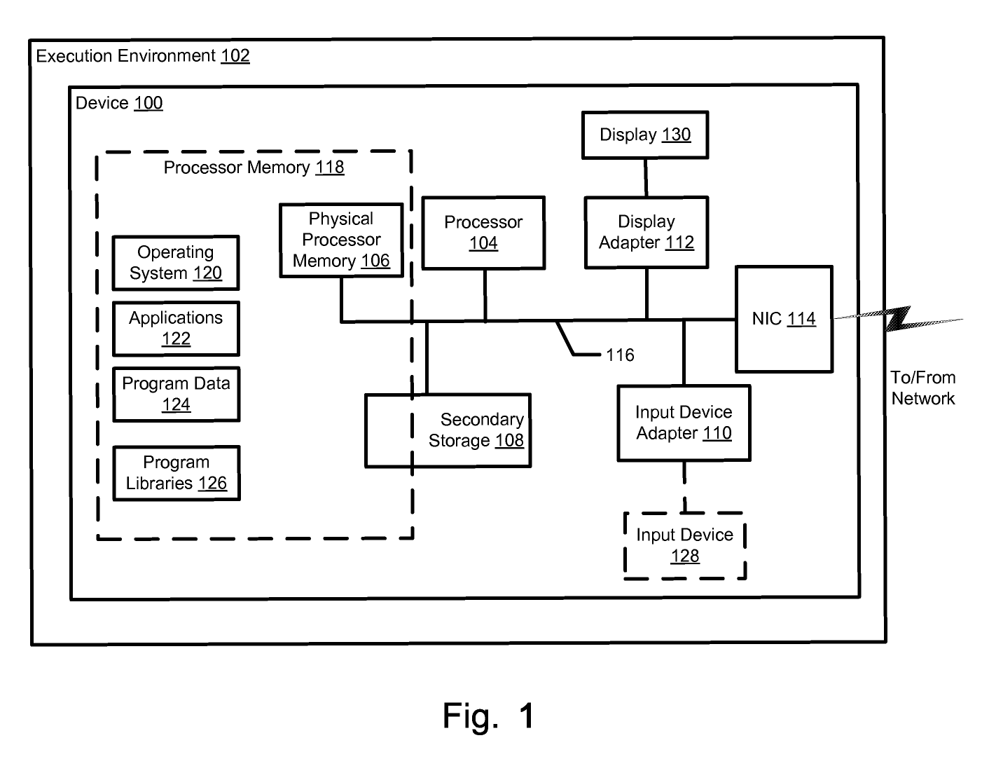

Those of ordinary skill in the art will appreciate that the components illustrated in FIG. 1 may vary depending on the execution environment implementation. An execution environment includes or is otherwise provided by a single device or multiple devices, which may be distributed. An execution environment typically includes both hardware and software components, but may be a virtual execution environment including software components operating in a host execution environment. Exemplary devices included in or otherwise providing suitable execution environments for configuring according to the subject matter include personal computers, servers, hand-held and other mobile devices, multiprocessor systems, consumer electronic devices, and network-enabled devices such as devices with routing and/or switching capabilities.

With reference to FIG. 1, an exemplary system for configuring according to the subject matter disclosed herein includes hardware device 100 included in execution environment 102. Device 100 includes an instruction processing unit illustrated as processor 104, physical processor memory 106 including memory locations that are identified by a physical address space of processor 104, secondary storage 108, input device adapter 110, a presentation adapter for presenting information to a user illustrated as display adapter 112, a communication adapter for communicating over a network such as network interface card (NIC) 114, and bus 116 that couples elements 104-114.

Bus 116 may comprise any type of bus architecture. Examples include a memory bus, a peripheral bus, a local bus, a switching fabric, etc. Processor 104 is an instruction execution machine, apparatus, or device and may comprise a microprocessor, a digital signal processor, a graphics processing unit, an application-specific integrated circuit (ASIC), a field programmable gate array (FPGA), etc.

Processor 104 may be configured with one or more memory address spaces in addition to the physical memory address space. A memory address space includes addresses that identify corresponding locations in a processor memory. An identified location is accessible to a processor processing an address that is included in the address space. The address is stored in a register of the processor and/or identified in an operand of a machine code instruction executed by the processor.

FIG. 1 illustrates that processor memory 118 may have an address space including addresses mapped to physical memory addresses identifying locations in physical processor memory 106. Such an address space is referred to as a virtual address space, its addresses are referred to as virtual memory addresses, and its processor memory is known as a virtual processor memory. A virtual processor memory may be larger than a physical processor memory by mapping a portion of the virtual processor memory to a hardware memory component other than a physical processor memory. Processor memory 118 illustrates a virtual processor memory mapped to physical processor memory 106 and to secondary storage 108. Processor 104 may access physical processor memory 106 without mapping a virtual memory address to a physical memory address.

Thus at various times, depending on the address space of an address processed by processor 104, the term processor memory may refer to physical processor memory 106 or a virtual processor memory as FIG. 1 illustrates.

Program instructions and data are stored in physical processor memory 106 during operation of execution environment 102. In various embodiments, physical processor memory 106 includes one or more of a variety of memory technologies such as static random access memory (SRAM) or dynamic RAM (DRAM), including variants such as dual data rate synchronous DRAM (DDR SDRAM), error correcting code synchronous DRAM (ECC SDRAM), or RAMBUS DRAM (RDRAM), for example. Processor memory may also include nonvolatile memory technologies such as nonvolatile flash RAM (NVRAM), ROM, or disk storage. In some embodiments, it is contemplated that processor memory includes a combination of technologies such as the foregoing, as well as other technologies not specifically mentioned.

In various embodiments, secondary storage 108 includes one or more of a flash memory data storage device for reading from and writing to flash memory, a hard disk drive for reading from and writing to a hard disk, a magnetic disk drive for reading from or writing to a removable magnetic disk, and/or an optical disk drive for reading from or writing to a removable optical disk such as a CD ROM, DVD or other optical media. The drives and their associated computer-readable media provide volatile and/or nonvolatile storage of computer readable instructions, data structures, program components and other data for the execution environment 102. As described above, when processor memory 118 is a virtual processor memory, at least a portion of secondary storage 108 is addressable via addresses within a virtual address space of the processor 104.

A number of program components may be stored in secondary storage 108 and/or in processor memory 118, including operating system 120, one or more applications programs (applications) 122, program data 124, and other program code and/or data components as illustrated by program libraries 126.

Execution environment 102 may receive user-provided commands and information via input device 128 operatively coupled to a data entry component such as input device adapter 110. An input device adapter may include mechanisms such as an adapter for a keyboard, a touch screen, a pointing device, etc. An input device included in execution environment 102 may be included in device 100 as FIG. 1 illustrates or may be external (not shown) to the device 100. Execution environment 102 may support multiple internal and/or external input devices. External input devices may be connected to device 100 via external data entry interfaces supported by compatible input device adapters. By way of example and not limitation, external input devices may include a microphone, joystick, game pad, satellite dish, scanner, or the like. In some embodiments, external input devices may include video or audio input devices such as a video camera, a still camera, etc. Input device adapter 110 receives input from one or more users of execution environment 102 and delivers such input to processor 104, physical processor memory 106, and/or other components operatively coupled via bus 116.

Output devices included in an execution environment may be included in and/or external to and operatively coupled to a device hosting and/or otherwise included in the execution environment. For example, display 130 is illustrated connected to bus 116 via display adapter 112. Exemplary display devices include liquid crystal displays (LCDs), light emitting diode (LED) displays, and projectors. Display 130 presents output of execution environment 102 to one or more users. In some embodiments, a given device such as a touch screen functions as both an input device and an output device. An output device in execution environment 102 may be included in device 100 as FIG. 1 illustrates or may be external (not shown) to device 100. Execution environment 102 may support multiple internal and/or external output devices. External output devices may be connected to device 100 via external data entry interfaces supported by compatible output device adapters. External output devices may also be connected to bus 116 via internal or external output adapters. Other peripheral output devices, not shown, such as speakers and printers, tactile, and motion producing devices may be connected to device 100. As used herein the term display includes image projection devices.

A device included in or otherwise providing an execution environment may operate in a networked environment using logical connections to one or more devices (not shown) via a communication interface. The terms communication interface and network interface are used interchangeably. Device 100 illustrates network interface card (NIC) 114 as a network interface included in execution environment 102 to operatively couple execution environment 102 to a network.

A network interface included in a suitable execution environment, such as NIC 114, may be coupled to a wireless network and/or a wired network. Examples of wireless networks include a BLUETOOTH network, a wireless personal area network (WPAN), a wireless 702.11 local area network (LAN), and/or a wireless telephony network (e.g., a cellular, PCS, or GSM network). Examples of wired networks include a LAN, a fiber optic network, a wired personal area network, a telephony network, and/or a wide area network (WAN). Such networking environments are commonplace in intranets, the Internet, offices, enterprise-wide computer networks and the like. In some embodiments, NIC 114 or a functionally analogous component includes logic to support direct memory access (DMA) transfers between processor memory 118 and other devices.

In a networked environment, program components depicted relative to execution environment 102, or portions thereof, may be stored in a remote storage device, such as, on a server. It will be appreciated that other hardware and/or software to establish a communications link between the device illustrated by device 100 and other network devices may be included.

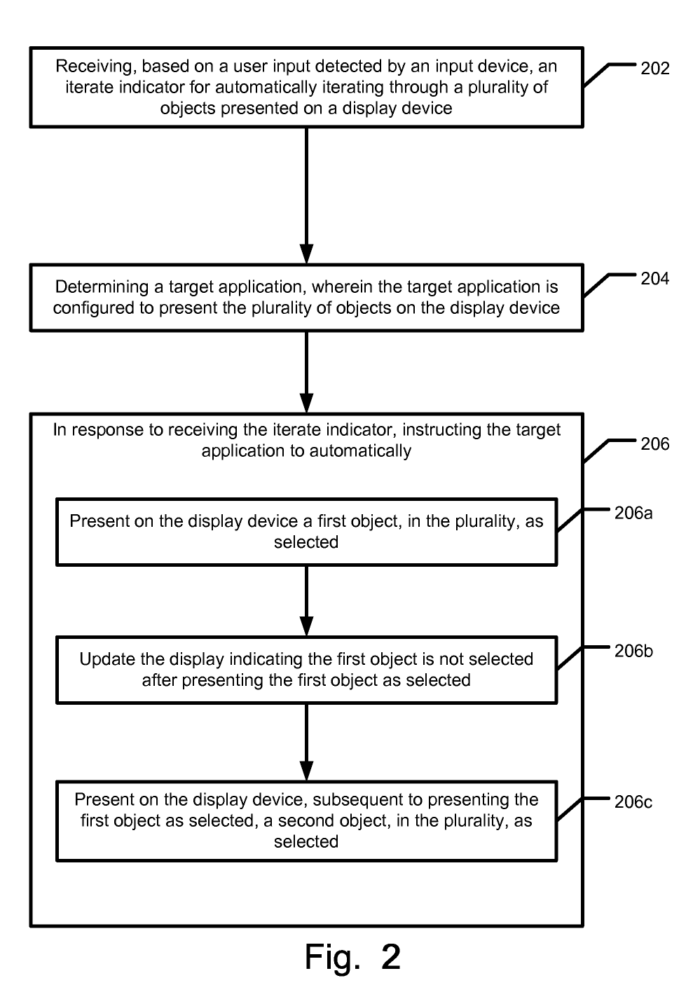

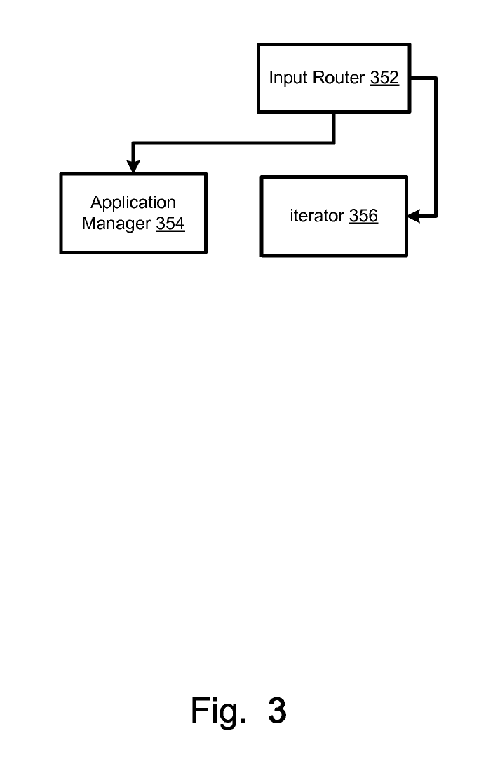

FIG. 2 is a flow diagram illustrating a method for automatically selecting objects in a plurality of objects according to an exemplary aspect of the subject matter described herein. FIG. 3 is a block diagram illustrating a an arrangement of components adapted to configuring an apparatus for automatically selecting objects in a plurality of objects according to another exemplary aspect of the subject matter described herein.

A system for automatically selecting objects in a plurality of objects includes an execution environment, such as execution environment 102, including an instruction processing machine, such as processor 104 configured to process an instruction included in at least one of an input router component, an application manager component, and an iterator component. The components illustrated in FIG. 3 may be adapted for performing the method illustrated in FIG. 2 in a number of execution environments. A general description is provided in terms of execution environment 102.

With reference to FIG. 2, block 202 illustrates the method includes receiving, based on a user input detected by an input device, an iterate indicator for automatically iterating through a plurality of objects. Accordingly, a system for automatically selecting objects in a plurality of objects includes means for receiving, based on a user input detected by an input device, an iterate indicator for automatically iterating through a plurality of objects. For example, as illustrated in FIG. 3, a input router component 352 is configured for receiving, based on a user input detected by an input device, an iterate indicator for automatically iterating through a plurality of objects.

The arrangement of component in FIG. 3 and analogs of the arrangement may operate in various execution environments, such as execution environment 102. A user input detected by input device 128 may be processed by various components operating in execution environment 102. The processing results in data received by and/or otherwise detected as an indicator by input router component 352. For example, input device adapter 110, operating system 120, and/or one or more routines in program library 126 may process input information based on the user input detected by input device 128.

One or more particular indicators may each be defined to be an iterate indicator by the arrangement of components in FIG. 3 and/or analogs of the arrangement. An indicator may be defined to be an iterate indicator based on a value identified by the indicator and/or based on a context in which the indicator is received. For example, input device 128 may detect a user press and/or release a down arrow key on a keyboard. A first detected user interaction with the down arrow key may result in input router component 352 receiving a direction indicator. A second or a third interaction with the down arrow key in a specified period of time may be defined to be an iterate indicator detectable by input router component 352. Thus various user inputs and patterns of inputs detected by one or more input devices may be defined as input indicators as detected by the arrangement of components in FIG. 3 and its analogs.

Alternatively or additionally, a user input may be detected by an input device operatively coupled to a remote device. Input information based on the user detected input may be sent in a message via a network and received by a network interface, such as NIC 114, operating in execution environment 102 hosting input router component 352. Thus, input router component 352 may detect an iterate indicator based on a message received from a remote device via a network.

In various aspects, an iterate indicator may included and/or otherwise identify additional information for automatically iterating through a plurality of objects presented on a GUI. For example, an iterate indicator may include and/or reference a number. The number may identify the number of objects in the plurality of objects to iterate over. A number may identify a maximum number of objects to iterate through. A number may identify a minimum number of objects in the plurality to iterate over. An iterate indicator may identify one or more numbers for one or more purposes.

In another aspect, an iterate indicator may include and/or otherwise identify a matching criteria for identifying objects in the plurality to iterate through. For example, a matching criteria may identify a type, such as a file type; a role such as a security role assigned to a person; a threshold time of creation; and/or a size.

In still another aspect, an iterate indicator may identify more than one matching criteria for more than one purpose. For example, a matching criteria may be associated with or otherwise identified by an iterate indicator to identify a first object in the plurality and/or to identify a last object in the plurality. Thus, an iterate indicator may identify a starting object and an ending object in the iteration process. Those skilled in the art will recognize based on the description included herein that an iterate indicator may be associated with or otherwise identify an ordering criteria for ordering the objects in the plurality.

An object is tangible, represents a tangible thing, and/or has a tangible representation. Thus, the term object may be used interchangeably with terms for things objects are, things objects represent, and/or representations of objects. For example, in a file system explorer window pane in a GUI presented on a display device, terms used interchangeably with object include file, folder, container, node, directory, document, image, video, application, program, and drawing. In other applications other terms may be used interchangeably depending on the other applications.

Block 204 in FIG. 2 illustrates the method further includes determining a target application, wherein the target application is configured to present a plurality of objects on a display device. Accordingly, a system for automatically selecting objects in a plurality of objects includes means for determining a target application, wherein the target application is configured to present a plurality of objects on a display device. For example, as illustrated in FIG. 3, a application manager component 354 is configured for determining a target application, wherein the target application is configured to present a plurality of objects on a display device.

A user input detected by input device 128 may be directed to a particular application operating in execution environment 102. FIG. 3 illustrates application manager component 354 configured to determine the target application. The target application may be one of a number of applications 122 operating in execution environment 102. Application manager component 354 is illustrated in FIG. 3 as operatively coupled to input router component 352. The coupling may be direct and/or indirect in various aspects.

In an aspect, application manager component 354 is configured to track user interface elements presented on display 130 to determine whether a user interface element has input focus. Application manager component 354 may determine the target application to be the application that owns and/or is otherwise responsible for the user interface element identified as currently having input focus. Alternatively or additionally, application manager component 354 may be configure to determine the target application based on a configured association between a particular detected user input and the target application, and/or a particular detecting input device and the target application. Other examples are provided below in the context of other exemplary execution environments.

A user interface element is an element or visual component of a graphical user interface (GUI). Exemplary user interface elements include windows, dialog boxes, textboxes, various types of button controls including check boxes and radio button, sliders, list boxes, drop down lists, spinners, various types of menus, toolbars, ribbons, combo boxes, tree views, grid views, navigation tabs, scrollbars, labels, tooltips, text in various fonts, balloons, and dialog boxes. Those skilled in the art will know that this list is not exhaustive. The terms visual representation and user interface element are used interchangeably in this document.

Various examples of additional information that may be included in and/or otherwise identified by an iterate indicator are described above. Additional information may be associated with an iterate indicator before it is detected by input router component 352. Alternatively or additionally, additional information may be included in and/or otherwise associated with a received iterate indicator by input router component 352. Alternatively or additionally, some or all additional information may be associated with a received iterate indicator by application manager component 354 and/or by input router component 352 interoperating with application manager component 354. Additional information; generated, located, and/or otherwise identified after the target application has been determined; may be generated, located, and/or otherwise identified based on the determined target application. Matching criteria for various purposes as described above may be identified based on the target application.

In aspect, a length of time may be associated with the iterate indicator based on the target application. For example, when objects in a plurality of objects presented by a target application require relatively more time for a user to view and understand than for another application, a length of time for processing each object in the plurality during iteration through the plurality may be relatively longer for the target application than for the other application.

A length of time associated with an iterate indicator and/or a target application may be a selection time identifying a length of time for presenting an object in a plurality of objects as a selected object. A length of time may be a selection overlap time identifying a time period during which a first object and a second object in the plurality may both be presented as selected on a display. A length of time may be an interval time identifying a length of time after a first object is presented as unselected after being presented as selected before a second object is presented as selected. The type of times described are exemplary and one or more time attributes may be associated with an iterate indicator and/or a target application for various purposes. A length of time may specify by a range, a fixed length, a maximum, and/or minimum measure of time in various aspects of the subject matter described herein.

Block 206 in FIG. 2 illustrates the method yet further includes, in response to receiving the iterate indicator, instructing the target application to automatically: present, on the display device, a first object, in the plurality, as selected; update the display device to indicate the first object is not selected after presenting the first object as selected; and present on the display device, subsequent to presenting the first object as selected, a second object, in the plurality as selected. Accordingly, a system for automatically selecting objects in a plurality of objects includes means for, in response to receiving the iterate indicator, instructing the target application to automatically: present, on the display device, a first object, in the plurality, as selected; update the display device to indicate the first object is not selected after presenting the first object as selected; and present on the display device, subsequent to presenting the first object as selected, a second object, in the plurality as selected.

For example, as illustrated in FIG. 3, a iterator component 356 is configured for, in response to receiving the iterate indicator, instructing the target application to automatically: present, on the display device, a first object, in the plurality, as selected; update the display device to indicate the first object is not selected after presenting the first object as selected; and present on the display device, subsequent to presenting the first object as selected, a second object, in the plurality as selected.

FIG. 3 illustrates iterator component 356 operatively coupled to input router component 352. The coupling may be direct and/or indirect. As illustrated, application manager component 354 may identify the determined application for input router component 352. The target application may be identified by identifying a user interface element presented by the target application.

Iterator component 356 may instruct the target application by invoking the target application a single time to iterate through the plurality of objects automatically without further user input to present a first object as selected, then present a second object as selected, and so on according to the number of objects in the plurality and additional information provided to the target application. In this aspect, the target application is configured to recognize the instruction provided in the single time it is provided. For example the target application may provide a function that may be invoked to be instructed.

For some applications, such as applications that are not configured to recognize an instruction to automatically present each object in the plurality as selected in a time sequence, iterator component 356 may be configured to invoke the target application to present a first portion of the plurality as described, then to invoke the target application a second time to present a second portion of the objects.

For example, iterator component 356 may invoke the target application a first time via one or more target application interfaces to present a first object on the display where the presentation of the first object indicates it is selected. Iterator component 356 may then subsequently and automatically invoke the target application a second time to present a second object on the display where the presentation of the second object indicates it is selected.

The target application may receive information instructing it to present the first object as not selected in the first invocation, the second invocation, and/or in a third invocation. The iterator component 356 may continue to automatically invoke the target application to continue presenting each object as selected in a time sequence.

In all aspects described, detecting a single iterate indicator is for instructing a target application to iterate through a plurality of objects presenting each object as selected on a display for a user. Iterator component 356 is configured to automatically instruct the target application to present sequentially in time each object, in the plurality of objects, as selected.

In an aspect, information included in, about, and/or otherwise associated with each object may be presented to the user as and/or while each object is presented as selected. The information associated with an object may be presented in a specified time period just prior to presenting an object as selected, while the object is presented as selected, and/or in a specified time period after the presentation of the object as selected is updated to present the object as not selected. Users may iterate through a number of objects without repeatedly entering input to select objects. Applications may be configured to take advantage of the subject matter described herein, however that is not required for some arrangements of components configured to perform the method illustrated in FIG. 2.

The first object in the plurality may already be selected prior to instructing the target application to iterate through the plurality of objects. Iterator component 356 may instruct a target application to continue presenting the first object as selected for a time either specified or bounded by a detectable event, such as another invocation of the target application by the iterator component 356. Iterator component 356 may be configured to instruct the target application to continue presenting the first object as selected by not instructing the target application to present the first object as unselected and/or otherwise preventing the un-selection of the first object.

For example, a pointer may be displayed in the same region of a display as an object presented by an application. A detected click of a left mouse button may be defined to be a selection indicator detected by one or more components, such as input router component 352. Examples of inputs that may be defined to be processed producing information detected as an iterate indicator by input router component 352 include a detected click of left and right mouse buttons, a click of a middle mouse button, and a click of mouse button along with a detected press of a particular key both detected in pre-specified time period and/or order.

In an aspect, iterator component 356 may identify the first object to the target application for presenting as selected first in the sequence of objects presented when it is not already selected. For example, a pointer may be displayed in the same region of a display as an object presented by an application. A detected click of a left mouse button may be defined to be a selection indicator detected by, for example, input router component 352. The input may be interpreted to be an iterate indicator and a selection indicator. Input information based on the input may be provided to the target application as a single indicator or multiple indicators.

In an aspect, an arrangement of components for performing the method illustrated in FIG. 2 may be configured to support a mode of operation, referred to in this document as repeat mode. When repeat mode is active, one or more particular inputs are defined as an iterate indicators. When repeat mode is not active, the one or more particular indicators are not defined to be interpreted as iterate indicators. For example, a user input detected by input device 128 may be defined as a selection indicator when repeat mode is not active. When repeat mode is active, the user input when detected is defined as an iterate indicator for a target application.

In such an arrangement, a start mode indicator may be detected by input router component 352. A mode may be set to indicate repeat mode is active, in response. The mode may be set by input router component 352 or another component in a hosting execution environment, such as iterator component 356.

When in repeat mode, one or more events in addition to detected user inputs may be interpreted as iterate indicators to initiate an iteration through a plurality of objects presented by a determined target application.

Repeat mode may be activated for one or more particular applications or may apply to all applications operating in execution environment 102. For example, when repeat mode is active a selection indicator directed to a second application may be detected as a selection indicator and an iterate indicator received by input router component 352. The second target application is determined by the application manager component 354. The iterator component 356, in response to detected indicator(s) while repeat mode is active, instructs the second target application to automatically present each object in a second plurality as selected in a sequential fashion as described above. The second target application may be further instructed to begin by presenting the selected object as the first selected object in the presented sequence.

Any detectable event may be defined to initiate a iteration through a plurality of objects according to the subject matter described herein. The event may be detected by an input device, a network interface, and/or any other component operating in a hosting execution environment. For example, while in repeat mode the creation, updating, or restoring on a window presenting a plurality of objects may be detected, a target application may be determined, such as the owning application of the window, and iterator component 356 may instruct the determined target application to present each object as selected in sequence as described. A presentation and/or update of an object on a display may also be defined to trigger an iteration through a plurality of objects including the object associated with the detected presentation and/or update. Iterator component 356 may identify and instruct the determined target application that the object associated with the detected event is to be presented as selected first in the sequence.

In a further aspect, a user input detected by input device 128 may be defined as an end mode indicator. The detected input may be a particular input statically defined as an end mode indicator. The input may be input device specific or not. Alternatively or additionally, a detected input may be defined as an end mode indicator depending on a particular state or context of an execution environment or application.

For example, a key or key pattern may be defined to activate repeat mode when repeat mode is not active and be defined as an end mode indicator for deactivating repeat mode when repeat mode is active. An end mode indicator may apply to all or some one or more applications operating in an execution environment. An end mode indicator may be specified to a particular application and or portion of an applications user interface

In another aspect, a start mode and/or an end mode indicator may be or may be generated in response to any other detectable event in an execution environment. Exemplary events include a time event such as detection of a specified time and/or end of a specified time period, a message received via a network; a change in an application such as closing or minimizing of a window, closing of an application, opening of a new application, presentation of a last object in a plurality of objects by an iteration process; and/or detecting an operation indicator based on a detected user input.

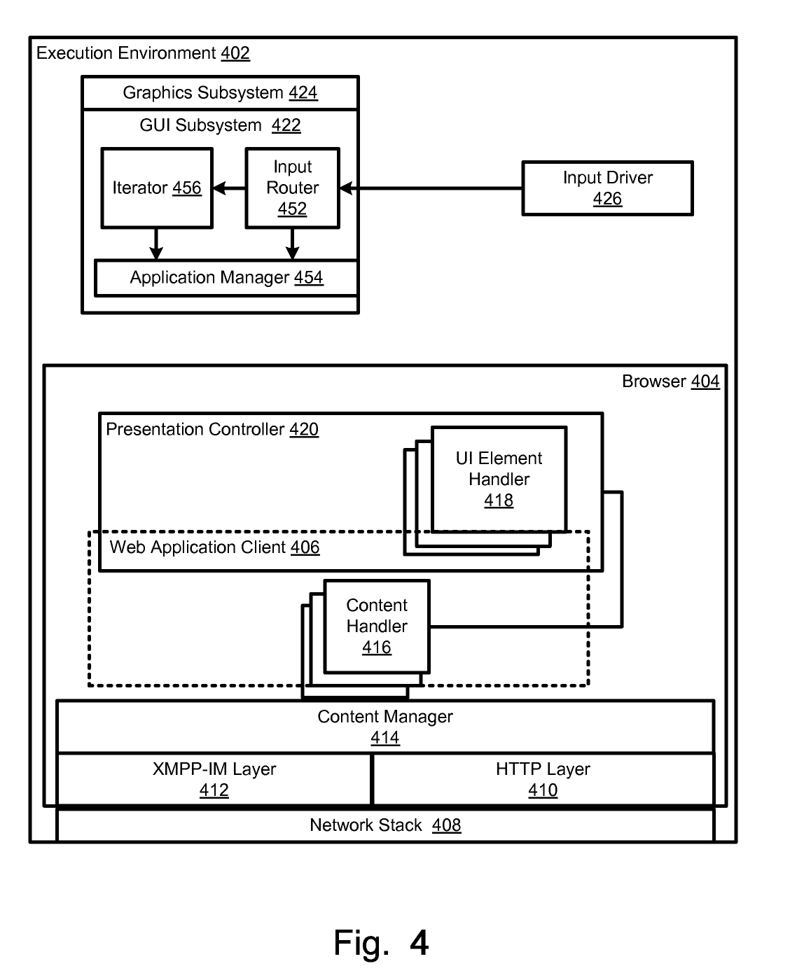

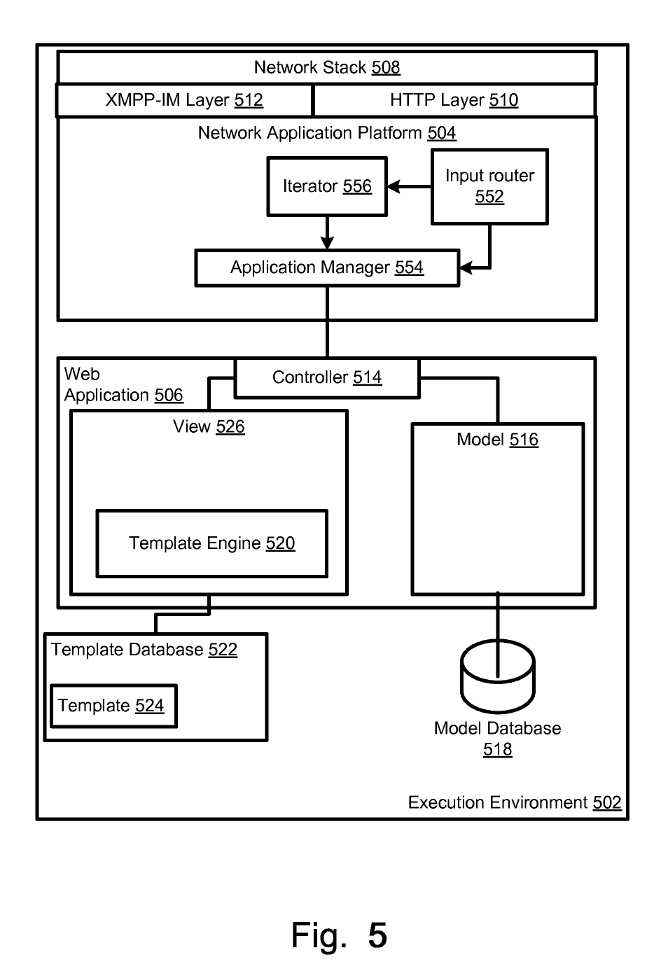

Adaptations of the components illustrated in FIG. 3 for performing the method illustrated in FIG. 2 are described operating in exemplary execution environment 402 illustrated in FIG. 4 including browser 404 and in exemplary execution environment 502 including network application platform 504 in FIG. 5.

FIG. 1 illustrates key components of an exemplary device that may at least partially provide and/or otherwise be included in an exemplary execution environment, such as those illustrated in FIG. 4 and FIG. 5. The components illustrated in FIG. 3, FIG. 4, and FIG. 5 may be included in or otherwise combined with the components of FIG. 1 to create a variety of arrangements of components according to the subject matter described herein

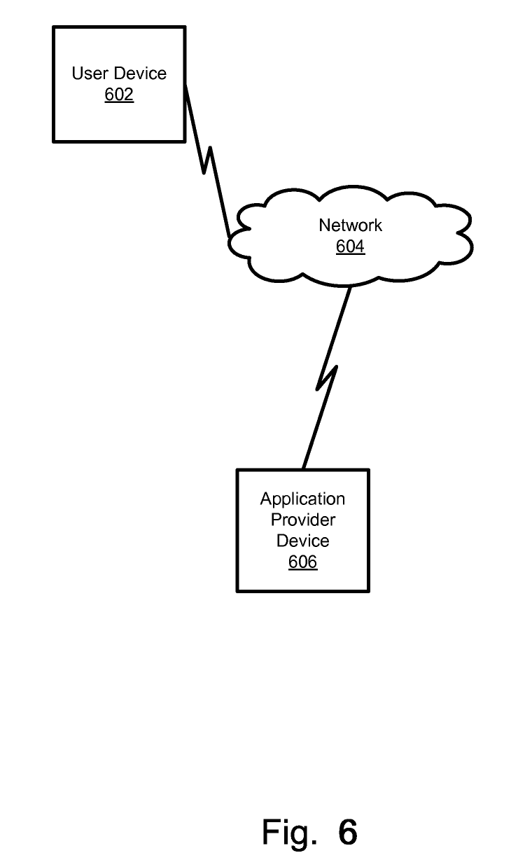

FIG. 6 illustrates a user device 602 as an exemplary device included in or otherwise providing execution environment 402. As illustrated in FIG. 6, user device is operatively coupled to network 604 via a network interface component, such as NIC 114. Alternatively, execution environment 402 includes and/or is otherwise provided by a device that is not operatively coupled to a network.

FIG. 4 illustrates browser 404 providing at least part of an execution environment for a network application. Web application client 406 is illustrated as executing in and/or otherwise being processed by various components of browser 404 to provide at least some of the services of its application provider illustrated as web application 506 in FIG. 5. Browser 404 operating in user node 602 may communicate with one or more application providers, such as network application platform 504 operating in application provider node 606 via network 604. Both execution environment 402 and execution environment 502 include a network interface, such as NIC 144 for sending and receiving data via network 604.

FIG. 4 illustrates network stack component 408 configured for sending and receiving messages over network 604, such as the Internet, via the network interface component of user device 602. FIG. 5 illustrates network stack component 508 serving in an analogous role in application provider device 606. Network stack component 408 and network stack component 508 may support the same protocol suite such as TCP/IP or may communicate via a network gateway or other protocol translation device.

FIG. 4 and FIG. 5 illustrate browser 404 and network application platform 504, respectively, configured to communicate via one or more application layer protocols, additionally or alternatively. FIG. 4 illustrates hypertext transfer protocol (HTTP) layer component 410 and instant messaging and presence protocol, XMPP-IM layer component, 412, as exemplary application protocol layer components. FIG. 5 illustrates compatible application protocol layer components; HTTP layer component 510 and XMPP-IM layer component 512, respectively.

In FIG. 4 browser 404 may receive web application client 406 via one more messages sent from web application 506 via network application platform 504 interoperating with one or more of the application layer components and/or network stack component 508. Browser 404 includes content manager component 414 configured to interoperate with one or more of the application layer components and/or network stack component 408 to receive web application client 406 via the one or more messages.

In an aspect, web application client 406 may include a web page for presenting a user interface for web application 506. The web page may include and/or reference data represented in one or more formats including hypertext markup language (HTML) and/or markup language, ECMAScript or other scripting language, byte code, image data, audio data, and/or machine code.

The data received by content manager component 414 may be received in response to a request sent in a message to web application 506 and/or may be received asynchronously in a message with no corresponding request.

In another aspect, in response to a request received from browser 404, controller component 514, in FIG. 5, invokes model subsystem 516 to perform request specific processing. Model subsystem 516 may include any number of request processors for dynamically generating data and/or retrieving data from a database component 518 based on the request. Controller component 514 may be further configured to invoke template engine component 520 to identify one or more templates 524 and/or static data elements for generating a user interface for representing a response to the received request. FIG. 5 illustrates a template database component 522 including an exemplary template 524. FIG. 5 illustrates template engine component 520 as a component of view subsystem 526. View subsystem 526 may be configured to generate and/or locate responses to received requests. The responses are formatted so that they are suitable for a client, such as browser 404. View subsystem 526 may provide a response including presentation data to controller component 514 to send to browser 404 in response to a request received from browser 404. Web application client 406 may be sent to browser 404 via network application platform 504.

Web application 506 additionally or alternatively may send some or all of web application client 406 to browser 404 via one or more asynchronous messages. An asynchronous message may be sent in response to a change detected by web application 506. A publish-subscribe protocol such as the specified presence protocol, XMPP-IM, is an exemplary protocol for sending messages asynchronously in response to a detected change.

The one or more messages including information representing web application client 406 may be received by content manager component 414 via one or more of the application protocol layer components and/or network stack component 408 as described above. FIG. 4 illustrates browser 404 includes one or more content handler components 416. A content handler component is configured to process received data according to its data type, typically identified by a MIME-type identifier.

Exemplary content handler components include a text/html content handler component for processing HTML documents; an application/xmpp-xml content handler component for processing XMPP streams including presence tuples, instant messages, and publish-subscribe data as defined by various XMPP specifications; one or more video content handler components for processing video streams of various types; and still image data content handler components for processing various images types

Content handler components 416 process received data and may provide a representation of the processed data to one or more user interface (UI) element handler components 418. User interface element handler components 418 are illustrated in a presentation controller component 420.

Presentation controller component 420 may be configured to manage the visual components of browser 404 as well as receive and route detected user and other input to components and extensions of browser 404. A user interface element handler component in various aspects may be adapted to operate at least partially in a content handler component such as the text/html content handler component and/or a script content handler component. Additionally or alternatively a user interface element handler component may be configured to operate in an extension of browser 404, such as a plug-in providing a virtual machine for script and/or byte code.

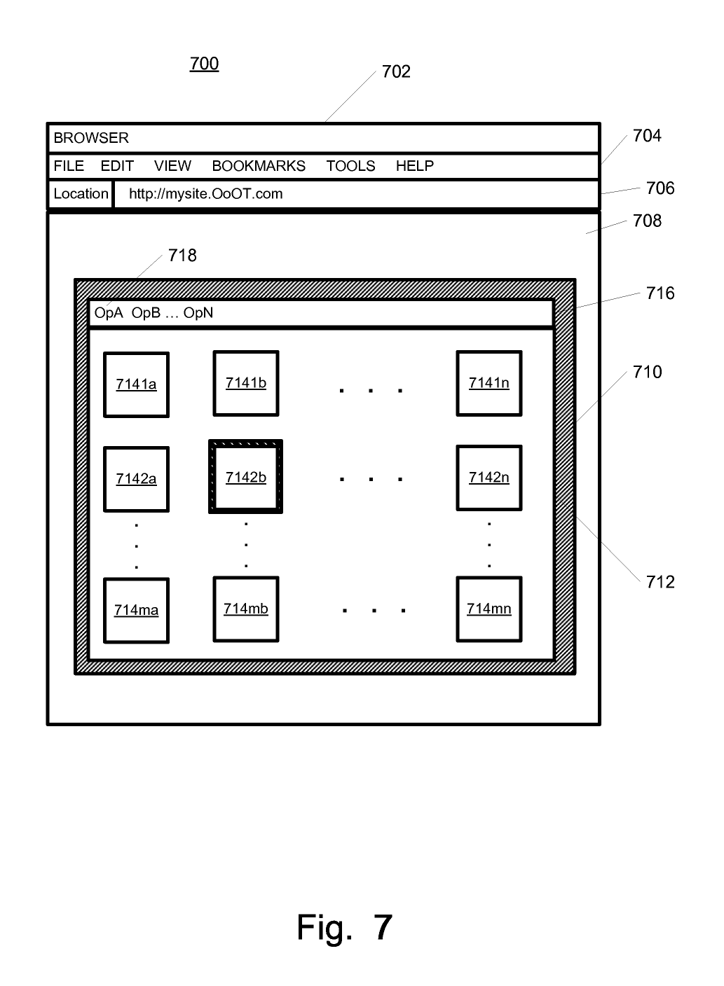

FIG. 7 illustrates an exemplary user interface 700 of browser 404. User interface 700 illustrates a number of user interface elements typically found in browsers including title bar 702, menu bar 704 including user interface elements visually representing various menus, a location bar 706. Location bar 706 includes a text user interface element representing a uniform resource locator (URL). The URL identifies a location or source of one or more elements presented in a presentation space of page/tab pane 708. The various user interface elements illustrated in page/tab pane 708 in FIG. 7 are visual representations based on representation information from a resource provider such as web application 506 in FIG. 5 and/or from web application client 406.

The various user interface elements of browser 404 are presented by one or more user interface elements handler components 418. In an aspect illustrated in FIG. 4, a user interface element handler component 418 of browser 404 is configured to send representation information representing a program entity, such as title bar 702 illustrated in FIG. 7 to GUI subsystem 422. GUI subsystem 422 may be configured to instruct graphics subsystem 424 to draw a user interface element in a region of a presentation space based on representation information received from a corresponding user interface element handler component 418.

Returning to FIG. 7, page/tab pane 708 includes task pane 710 included in a user interface of web application 506 operating in application provider device 606 and in browser 404 as web application client 406. Task pane 710 includes an object window 712 including visual representations of various objects of web application 506 and/or web application client 406 illustrated as object icons 714.

Object icon 7142b is a first visual representation of a first object. The first object is represented as selected as indicated by a visually distinguishing attribute of the first visual representation. In FIG. 7, object icon 7142b is presented with a thicker border than other object icons 714. Those skilled in the art will recognized that there are numerous visual attributes usable for representing a visual representation as selected.

FIG. 7 also illustrates operation bar 716. A user may move a mouse to move a pointer presented on display 130 over an operation identified in operation bar 716. The user may provide an input detected by the mouse. The detected input is received by GUI subsystem 422 via input driver component 426 as an operation indicator based on the association of the shared location of pointer and the operation identifier on display 130.

FIG. 4 illustrates input router component 452 as an adaption of and/or analog of input router 352 in FIG. 3. FIG. 4 illustrates input router component 452 operating external to browser 404 and other applications it serves in execution environment 402. As illustrated in FIG. 4, input router component 452 is configured for receiving, based on a user input detected by an input device, an iterate indicator for automatically iterating through a plurality of objects.

In the arrangement of components illustrated in FIG. 4, input router component 452 is configured to receive an input indicator from input driver component 426. Input driver component 426 is operatively coupled to input device adapter 110 which receives input information from input device 128, in response to an input from a user. Input driver component 426 generates an input indicator based on the input and provides the input indicator to input router component 452. The input indicator is received and/or otherwise detected by input router component 452 in one or more interactions with input driver component 426. An input indicator may identify the source of the corresponding detected input, such as a keyboard and one or more key identifiers.

Input router component 452 may be configured to recognized one or more input indicators as system defined input indicators that may be processed according to their definition(s) by GUI subsystem 422 and its included and partner components. Other inputs may be application defined and input router component 452 may be configured to pass these input indicators for routing to an application for processing. Some input indicators may be system defined and further defined by receiving applications.

One or more particular indicators may be defined as an iterate indicator or iterate indicators by various adaptations of the arrangement of components in FIG. 3, such as the components in FIG. 4. In FIG. 4, when input router component 452 detects the iterate indicator, input router component 452 is configured to interoperate with application manager component 454 and iterator component 456 to further process the iterate indicator as configured by the particular arrangement of components.

In an aspect, FIG. 7, illustrates object 7142b as a selected object. An input, such as mouse click may be detected while a pointer user interface element is presented over an operation indicator, such as OpA 718. The mouse click may be detected while repeat mode is active identifying the operation indicator as an iterate indicator. Alternatively, the mouse click may be detected in correspondence with a another detected user input, such as a <shift> key press defined to identify the corresponding operation indicator as an iterate indicator.

In a further, aspect, a mouse click may be detected while the pointer user interface element is over object 7142b. Object 7142b may be presented as selected prior to and during detection of the mouse click or may be presented as unselected. The detected mouse click corresponding to the presented object 7142b may be defined to be and/or produce an iterate indicator either when detected by itself and/or in correspondence with another input and/or attribute detectable in execution environment 402. Alternatively, as described above, the mouse click on object 7142b may be received while repeat mode is active, thus defining the mouse click as an iterate indicator in the context in which it is detected.

FIG. 4 illustrates application manager component 454 as an adaption of and/or analog of application manager component 354 in FIG. 3. One or more application manager components 454 operate in execution environment 402. As illustrated in FIG. 4, application manager component 454 is configured for determining a target application, wherein the target application is configured to present a plurality of objects on a display device

An input indicator detected by input router component 452 may be directed to a particular application operating in execution environment 402. Input router component 452 may be configured to provide information to application manager component 454 to determine the target application.

In an aspect, GUI subsystem 422 is configured to track a window, dialog box, and/or or other user interface element presented on display 130 to determine which of the one or more user interface elements has input focus. Application manager component 454 may determine a user interface element in user interface 700 has input focus when an input from a keyboard is received.

Alternatively or additionally, application manager component 454 operating in GUI subsystem 422 may be configured to determine the target application based on a configured association between an input detected by a pointing device and a position of a mouse pointer on display 130. For example, a mouse click and/or other input is detected while a pointer user interface element is presented over a visual component of task pane 710. Task pane 710 is a visual component of user interface 700 of browser 404.

Application manager component 454 operating in GUI subsystem 422 may be configured to track positions of various user interface elements including the mouse pointer and visual components of user interface 700. Input router component 452 may interoperate with application manager component 454 providing position information. Based on the locations of the pointer user interface element in user interface 700 and the source input device (a mouse), application manager component 454 may associate the input with browser 404.

As those skilled in the art will know, a user interface element with input focus typically is the target of keyboard input. When input focus changes to another user interface element, keyboard input is directed to the user interface element with input focus. Thus application manager component 454 may determine a target application based on a state variable such as a focus setting and based on the detecting input device. A focus setting may apply to all input devices or a portion of input devices in an execution environment. Different input devices may have separate focus settings associated input focus for different devices with different applications and/or user interface elements.

Alternatively or additionally, an input device and/or a particular detected input may be associated with a particular application, a particular region of a display, or a particular user interface element regardless of pointer position or input focus. For example, a region of a display may be touch sensitive while other regions of the display are not. The region may be associated with a focus state, a pointer state, or may be bound to a particular application.

In another example, a pointing input, such as a mouse click, is detected corresponding to a presentation location of user interface element, OpA 718. Identifying an operation to be performed on a selected object, object 7142b. Application manager component 454 may identify browser 404 as the target application.

In an aspect, application manager component 454 may determine a user interface element handler component 418 corresponding the visual representation of OpA 718 or object 7142b and, thus, identify web application client 406 as the target application via identifying a user interface element handler component of web application client 406. Additionally or alternatively, by identifying browser 404 and/or web application client 406, application manager component 454 indirectly may determine web application 506 as the target application depending on the configuration of browser 404, web application client 406, and/or web application 506.

FIG. 4 illustrates iterator component 456 as an adaption of and/or analog of iterator component 356 in FIG. 3. One or more iterator components 456 operate in execution environment 402. As illustrated in FIG. 4, iterator component 456 is configured for in response to receiving the iterate indicator, instructing the target application to automatically: present, on the display device, a first object, in the plurality, as selected; update the display device to indicate the first object is not selected after presenting the first object as selected; and present on the display device, subsequent to presenting the first object as selected, a second object, in the plurality as selected.

FIG. 4 illustrates iterator component 456 operating as a component of GUI subsystem 422, operatively coupled to input router component 452. The coupling may be direct and/or indirect. As described, application manager component 454 may identify the determined application to input router component 452. The target application may be identified based on a user interface element presented by the target application, for example.

Iterator component 456 may instruct web application client 406 as the target application by communicating with web application client 406 via browser 404 a single time providing one or more directives, instructions, commands, and/or indications to iterate through the plurality of objects 714 automatically without further user input. As described the iteration process is for presenting first object 7142b as selected if it is not already presented as selected, then present a second object as selected, and so on according to the number of objects in the plurality. Web application client 406, in this example, is configured to recognize the iterate instruction(s) provided in the single communication with iterator component 456.

Alternatively, iterator component 456 may communicate with web application client 406 multiple times to sequentially and automatically present each object in the plurality as selected.

In all aspects, detecting a single iterate indicator is sufficient for the arrangement of components to automatically instruct web application client 406 to iterate through objects 714 or a subset of objects 714 if a filter defines the plurality of objects to iterate through. Iterator component 456 sends information to web application client 406 to present each object as selected on display 130. Web application client 406 may be configured to iterate and additionally operate on objects 714 with or without communication with web application 506. Iterator component 456 is configured to instruct the target application to automatically present sequentially in time each object, in the plurality of objects, as selected, in response to receiving the iterate indicator.

In an aspect, a user input may be detected to indicate an operation to perform on one or more of the objects as each is object is presented as selected. A script routine included in web application client 406 may be configured to interoperate with one or more user interface element handler components 418 to sequentially present the objects 714 as selected.

Alternatively or additionally, web application client 406 may be configured to send a message as a request to web application 506 identifying each object 714 as it is selected. In a response, sent by web application 506, web application client 406 may receive information identifying a next object 714 for selection.

As each object is presented as selected, an operation may be performed on some or all of the objects 714. The operation may be specified in an operation indicator detected along with the iterate indicator. For example, OpA 718 may be an operation to change the owner of some or all of objects 714 as they are presented. As each object 714 is presented as selected, the owner may be changed as specified in a dialog presented in response to detecting a user selection of OpA 718.

Alternatively or additionally, the owner change may be applied only when a confirmation input is received from the user as each object 714 is presented as selected. Conversely, the owner may be changed for each object presented as selected unless a user input is detected that is defined as a skip indicator for instructing web application client to move on to the next object 714 without performing the operation on the currently selected object.

In an aspect, rather than receiving a specific operation indicator, an operation may be performed on each object based on an attribute of each object such as its size, type, owner, creation date, and/or permissions. Web application client 406 may be configured to perform an operation in response to receiving instruction(s) to iterate through the objects 714 where an operation indicator is included in the instruction(s) and/or may perform one or operations on its own without instruction from iterator component 456. For example, web application client 406 may be configured to present metadata for each object 714 as each object is presented as selected. The metadata may be or may include user supplied annotation information, historical information, and/or status information. The metadata may be retrieved via request from web application client 406 to web application 506. Alternatively, the information may be received by web application client 406 in asynchronous messages from web application 506. Each message may also indicate to web application client 406 to present a next object as selected.

As described above with respect to FIG. 3 and FIG. 1, the arrangement of components in FIG. 4 for performing the method illustrated in FIG. 2 may be configured to support repeat mode defining a state in which iterate indicator definitions are actively processed. Browser 404 may provide a toolbar button to activate repeat mode for applications operating at least partly in browser 404. Alternatively, a function key, such as <F9> may be defined to activate repeat mode for a group of applications operating at least partially in execution environment 402. A mode indicator may be maintained by iterator component 456 or another component directly or indirectly coupled to any of the components of FIG. 3 adapted for operation in execution environment 402.

While the components illustrated in FIG. 3 have been described as adapted for operation in execution environment 402 and described as adapted for operating in execution environment 502, those skilled in the art will see based on the description provided in this document, that the components in FIG. 3 may be adapted to operate in an execution environment that includes at least a portion of execution environment 402 and execution environment 502. In such an execution environment some adaptations of components in FIG. 3 may operate in execution environment 402 while others may operate in execution environment 502. Alternatively or additionally, at least some components in FIG. 3 may be adapted to operate partially in both execution environments in some embodiments.

As mentioned, a target application may be desktop application, a browser 404, or other application operating in a browser. A target application, in further aspect, may be an application or a portion of an application operating in a remote device as illustrated by web application 506 operating in execution environment 502 of application provider node 606. Adaptations and/or analogs of the components in FIG. 3 may operate in execution environment 402 as shown and described above which service applications operating in browser 404 and/or in application provider device 606. Alternatively or additionally, adaptations and/or analogs of the components in FIG. 3 may be included in browser 404 and/or an extension of browser 404 to service applications operating at least partly in browser 404 and/or at least partly in devices of remote providers, such as application provider device 606.

Adaptations and/or analogs of the components in FIG. 3 may serve one or more network applications operating in application provider device 606 as target applications in performing the method illustrated in FIG. 2. An exemplary arrangement of this sort is illustrated in FIG. 5 operating in network application platform 504. Network application platform 504 my provide services to one or more network applications such as web application 506.

FIG. 5 illustrates input router component 552 as an adaption of and/or analog of input router component 352 in FIG. 3. FIG. 5 illustrates input router components 552 operating external to web application 506 and other applications it serves in execution environment 502. As illustrated in FIG. 5, input router component 552 is configured for receiving, based on a user input detected by an input device, an iterate indicator for automatically iterating through a plurality of objects.

In FIG. 5, input router component 552 is configured to receive an input indicator in a message from a client device. As described above, various inputs associated with operation indicators, such as OpA 718, keyboard inputs, and inputs corresponding to an object 714 whether selected or unselected may be detected as input indicators based on information received in messages by input router component 552. One or more input indicators detected by input router component 552 may be detected as an iterate indicator and/or a combination indicator(s), such as an iterate and operation indicator

As described with respect to various aspects of FIG. 4, start mode and end mode indicators may be supported and received in messages from remote client devices. Input router component 552 may detect indicators for activating and/or deactivating repeat mode in messages from user device 602.

Input router component 552 may receive raw unprocessed input information and be configured to detect an iterate indicator based on the information. Alternatively, browser 404 and/or web application client 406, may be configured to detect an iterate indicator from received input information, and send a message including information defined to identify an iterate indicator based on a configuration of browser 404 and/or web application client 406, and input router component 552. That is, either or both client and server may be configured to detect an iterate indicator as described in this document. The form an iterate indicator takes may vary between client and server depending on the execution environment and configuration of a particular input router component.

As with input router component 452, input router component 552 may be configured to forward input indicators not defined by network application platform to an application serviced by network application platform 504 for detection and processing.

### Input Router Component 554

As described and exemplified above, in FIG. 4, in FIG. 6, and in FIG. 7, input router component 552 in FIG. 5 operating in application provider device 606 is configured to receive an operation indicator, based on a user input detected by input device 128 operating in user device 602. As the described the target application may be an application of application service provider 606, such as web application 506.

In the arrangement of components illustrated in FIG. 5, input router component 552 is configured to receive an input indicator and/or information for detecting an input indicator in one or more messages via network 604. The one or more messages may be from a client device, such as user device 602, accessing one or more applications serviced by network application platform 504.

For example a user input detected by user device 602 as described above may be processed by components in execution environment 402 to send a message to application provider device 606. Information generated in response to a mouse click on object 7142b may be provided to browser 404 and/or web application client 406 for processing. The processing may include a request to content manager component 414 to send a message to web application 506 via network 604 as described.

Input router component 552 may be configured to recognized one or more input indicators as network application platform 504 defined input indicators to be processed according to their definition(s) by components and/or applications interoperating with network application platform 504. Other inputs may be application defined and input router component 552 may be configured to pass these input indicators for routing to an application for processing. Some input indicators may be system defined and further defined by receiving applications.

One or more particular indicators may be defined as an iterate indicator or iterate indicators in the arrangement of components in FIG. 5. In FIG. 5, when input router component 552 detects an iterate indicator, input router component 552 is configured to interoperate with application manager component 554 and iterator component 556 to further process the iterate indicator as configured by the particular arrangement of components.

In an example, FIG. 7 shows object 7142b as a selected object. An input, such as touch may be detected in a region of display 130 of user device 602 including user interface element for object 7142b. The tactile input may be defined as a selection indicator. Input router component 552 may receive a message from browser 404 and/or web application client 406 sent in response to the detected input. The message may include information based on the detected input which input router component 552 is configured to detect as an iterate indicator. Input router component 552 may detect the information as an iterate indicator while repeat mode is active if input router component 552 is configured to support modal operation.

Alternatively or additionally, the touch may be detected in correspondence with a user press of a function key that may be sent to browser 404 and/or web application client 406. Browser 404 and/or web application client 406 may send a message to application provider device 606 including information routed to input router component 552. Input router component 552 may identify the detected combination of inputs as an iterate indicator. In an aspect, web application client 406 may detect the combination of detected inputs and send a message identifying an iterate indicator hiding input details from network application platform 504.

As with execution environment 402, in a further, aspect, a touch, mouse click, or other input may be detected corresponding to an operation control, such as OpA 718. An object, such as object 7142b, may be presented as selected prior to and during detection of the detected input corresponding to the operation indicator of OpA 718 or may be presented as unselected. An input corresponding to an operation control may be defined to be and/or produce an iterate indicator based on information sent in a message to application provider device 606 in response to the detected input. Further, as described above, the detected input corresponding to OpA 718 may be received while repeat mode is active in network application platform, thus defining the input information received by input router component 552 resulting from the detected user input as an iterate indicator in the context in which it is detected.

FIG. 5 illustrates application manager component 554 as an adaption of and/or analog of application manager component 354 in FIG. 3. One or more application manager components 554 operate in execution environment 502. As illustrated in FIG. 5, application manager component 554 is configured for determining a target application, wherein the target application is configured to present a plurality of objects on a display device.

An iterate indicator detected by input router component 552 may be directed to a particular application operating in execution environment 502. Input router component 552 may be configured to provide information to application manager component 554 to determine the target application, such as a portion of a universal resource locator (URL) included in the message identifying an iterate indicator.

In an aspect, application manager component 522 is configured to maintain records identifying an application configured to use network application platform 504 and a URL or a portion of a URL such as a path portion. Network application platform 504 associates received messages with applications serviced by network application platform 504, such as web application 506, based on the maintained records. Each application may be associated with one or more identifiers based on a URL. Messages received by network application platform 504, such as HTTP messages, may include some or all of a URL. The application manager component 554 may locate a record based on the URL in a received message to identify the target application for the message identified by the URL in the located record.

Alternatively or additionally, a target application may be identified by application manager component 554 based on a protocol in which a message from a client is received. For example, a presence service may be configured as the target application for all messages conforming to a particular presence protocol. Application manager component may additionally or alternatively determine a target application based on a tuple identifier, a port number associated with sending and/or receiving the received message, information configured between a particular client and network application platform, an operation indicator, and/or a user and/or group identifier too name a few examples.

In an aspect, a message from browser 404 and/or web application client 406 may identify a particular user interface element presented in page/tab pane 708 of user interface 700 of browser 404 and web application client 406. Application manager component 554 may identify a target application based on information the particular user interface element corresponding to a user detected input detected by user device 602.

In an example, a touch input may be detected corresponding to an object 714, such as object 7142b. A message including a URL identifier of web application 506 may be received by input router component 552. Application manager component 554 may identify web application 506 as the target application. In an aspect, application manager component 554 may determine a component of view subsystem 526 and/or model subsystem 516 corresponding the object visually represented by the user interface element object 7142b, and thus identify web application 506 as the target application via identifying a corresponding component of web application 506.

FIG. 5 illustrates iterator component 556 as an adaption of and/or analog of iterator component 356 in FIG. 3. One or more iterator components 556 operate in execution environment 502. As illustrated in FIG. 5, iterator component 556 is configured for in response to receiving the iterate indicator, instructing the target application to automatically: present, on the display device, a first object, in the plurality, as selected; update the display device to indicate the first object is not selected after presenting the first object as selected; and present on the display device, subsequent to presenting the first object as selected, a second object, in the plurality as selected.

FIG. 5 illustrates iterator component 556 operating as a component of network application platform 504, operatively coupled to input router component 552 and application manager component 554. The couplings may be direct and/or indirect. As described, application manager component 554 may identify the target application to input router component 552. Alternatively or additionally, application manager component 554 may identify the target application to iterator component 556. The target application may be identified based on a URL or other information in and/or otherwise associated with a received message as described above.

Iterator component 556 may instruct the web application 506 as the target application by communicating with web application 506, via application manager component 554, and/or via some other component. Iterator component 556 may communicate with web application 506 a single time providing one or more directives, instructions, commands, and/or indications for iterate through the plurality of objects 714 without further user input, in a manner analogous to that described above with respect to FIG. 3 and FIG. 4. The iteration process as instructed is for presenting first object 7142b as selected, if it is not already presented as selected, then present a second object as selected, and so on according to the number of objects in the plurality. Web application 506 may send one or more messages to browser 404 to update web application client 406 to sequentially present the selected objects as described above.

Alternatively, iterator component 556 may communicate with web application 406 multiple times to sequentially and automatically present each object in the plurality as selected. Iterator component 556 may send the multiple messages in response to a single message from user device 602 or iterator component 556 may instruct web application in response to multiple messages from user device 602. For example, as described above web application client 406 may send a message for each object presented as selected.

In all aspects, detecting a single iterate indicator is sufficient for the arrangement of components to instruct web application 506 to automatically iterate through objects 714 or a subset of objects 714 if a filter defines the plurality of objects to iterate through. Iterator component 556 sends information to web application 506 to present each object as selected on display 130 of user device 602. Iterator component 556 is configured to instruct the target application to automatically present sequentially in time each object, in the plurality of objects, as selected, in response to receiving the iterate indicator.

In an aspect, a specified input detected by a specified input device is defined as start mode indicator that places a detecting system into a repeat mode when it is detected. The start mode indicator is received along with one or more operation indicators received during repeat mode. An end mode indicator may be received by iterator component 556. Iterator component 556 may end repeat mode in response to receiving the end mode indicator. An end mode indicator may be based on an input detected by a device. The input may be the same input as the input for the start mode indicator except that input resulting in the end mode indicator is received when repeat mode is active. Alternatively, an end indicator may be based on a different input from the same and/or different input device.

Exemplary arrangements of components and processes for communicating input information and corresponding input indicators from user device 602 to application provider device 606 are provided above and are not repeated here. A start mode indicator may be received by application provider device 606 in the same message from user device and/or may be received in separate messages. A start mode indicator or information for generating a start mode indicator received by a web application client 406 operating in browser 404 by the input device while repeat mode is active. Iterator component 556 operating in network application platform 504 may send an indicator in the session data placing the session in repeat mode. An end mode indicator may be received by iterator component 556 to end repeat mode for the session.

Alternatively, web application client 406 may operate in a modal manner activating repeat mode in browser 404 for the session with web application 506, while web application 506 operates in a modeless manner. Thus, repeat mode may be supported without web application 506 configured to operate in a model manner.

Combinations of the above alternatives are possible. Iterator component 556 may maintain mode information for some applications operating in execution environment 502 that provide web application clients that do not maintain mode information. Of course, both a web application client and a web application may operate modelessly and a web application client and a web application may both maintain at least some mode information supporting repeat mode operation.

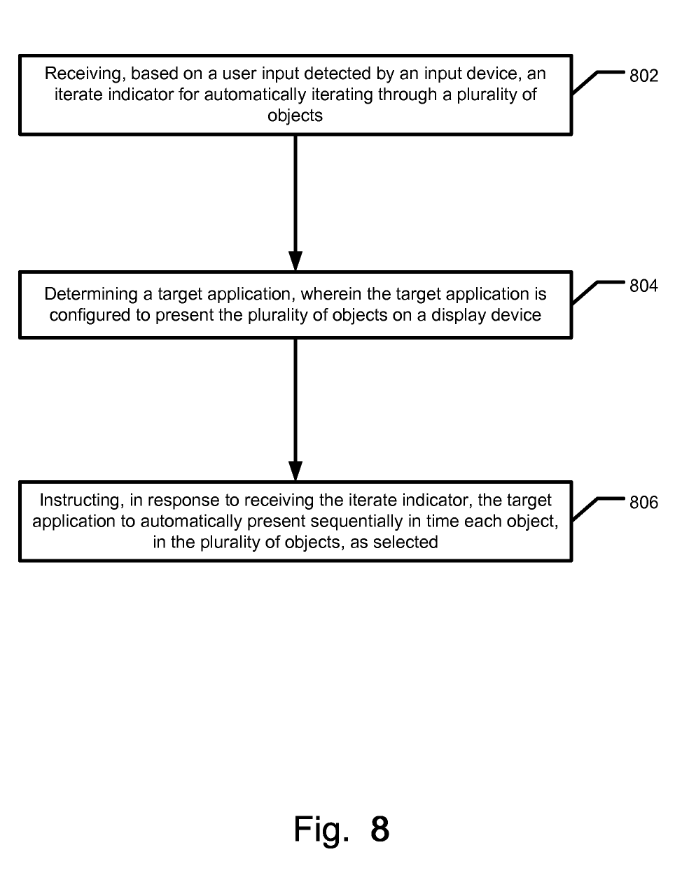

FIG. 8 is a flow diagram illustrating a method for automatically selecting objects in a plurality of objects according to an exemplary aspect of the subject matter described herein. FIG. 3 is a block diagram illustrating an arrangement of components for automatically selecting objects in a plurality of objects according to another exemplary aspect of the subject matter described herein.

A system for automatically selecting objects in a plurality of objects includes an execution environment, such as execution environment 102, including an instruction processing machine, such as processor 104 configured to process an instruction included in at least one of an input router component, an iterator component, a application manager component, and an iterator component. The components illustrated in FIG. 3 may be adapted for performing the method illustrated in FIG. 8 in a number of execution environments. A general description is provided in terms of execution environment 102.

FIG. 4 and FIG. 5 illustrate the components of FIG. 3 and/or their analogs adapted for operation in execution environment 402 and execution environment 502, respectively, provided by one or more nodes. The method illustrated in FIG. 8 may be carried out by, for example, some or all of the exemplary arrangements of components illustrated in FIG. 3, FIG. 4, FIG. 5, and their analogs as described above.

With reference to FIG. 8, block 802 illustrates the method includes receiving, based on a user input detected by an input device, an iterate indicator for automatically iterating through a plurality of objects. Accordingly, a system for automatically selecting objects in a plurality of objects includes means for receiving, based on a user input detected by an input device, an iterate indicator for automatically iterating through a plurality of objects. For example, as illustrated in FIG. 3, a input router component 352 is configured for receiving, based on a user input detected by an input device, an iterate indicator for automatically iterating through a plurality of objects.

Block 804 in FIG. 8 illustrates the method further includes determining a target application, wherein the target application is configured to present the plurality of objects on a display device. Accordingly, a system for automatically selecting objects in a plurality of objects includes means for determining a target application, wherein the target application is configured to present the plurality of objects on a display device. For example, as illustrated in FIG. 3, application manager component 354 is configured for determining a target application, wherein the target application is configured to present the plurality of objects on a display device.

Block 806 in FIG. 8 illustrates the method yet further includes in response to receiving the iterate indicator, instructing the target application to automatically present sequentially in time each object, in the plurality, as selected. Accordingly, a system for automatically selecting objects in a plurality of objects includes means for in response to receiving the iterate indicator, instructing the target application to automatically present sequentially in time each object, in the plurality, as selected. For example, as illustrated in FIG. 3, a iterator component 356 is configured for in response to receiving the iterate indicator, instructing the target application to automatically present sequentially in time each object, in the plurality, as selected.

It is noted that the methods described herein, in an aspect, are embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media are included which may store data that is accessible by a computer, such as magnetic cassettes, flash memory cards, digital video disks, Bernoulli cartridges, random access memory (RAM), read-only memory (ROM), and the like.

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include in one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various of the acts and operation described hereinafter may also be implemented in hardware.

To facilitate an understanding of the subject matter described below, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the best mode known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

I claim:

1. A method for automatically selecting objects in a plurality of objects, the method comprising:
receiving, based on a user input detected by an input device, an iterate indicator for automatically iterating through a plurality of objects;
determining a target application, wherein the target application is configured to present a plurality of objects on a display device; and
in response to receiving the iterate indicator, instructing the target application to automatically
present, on the display device, a first object, in the plurality, as selected;
update the display device to indicate the first object is not selected after presenting the first object as selected; and
present on the display device, subsequent to presenting the first object as selected, a second object, in the plurality as selected.

2. The method of claim 1 wherein receiving the iterate indicator includes receiving the iterate indicator based on a message received from a remote device via a network, wherein the message includes input information based on the user input detected by the input device.

3. The method of claim 1 wherein the iterate indicator includes a count identifying at least one of a maximum, minimum, and exact number of objects in the plurality of objects to present as selected on the display device.

4. The method claim 1 wherein the iterate indicator identifies a matching criteria for identifying objects in the plurality.

5. The method of claim 1 wherein the iterate indicator identifies a last object matching criteria for identifying a last object in the plurality to present as selected on the display device.

6. The method of claim 1 further comprising providing at least one of a selection time period identifying a period of time for presenting an object in the plurality as selected, an overlap time period identifying a length of time the first object and the second are simultaneously presented on the display as selected, and an interval time period identifying a length of time the first object is presented as not selected before presenting the second object as selected.

7. The method of claim 1 wherein instructing includes identifying the first object to the target application.

8. The method of claim 1 wherein the instructing comprises;
invoking the target application a first time to present the first object as selected; and
automatically invoking the target application a second time to present the second object as selected.

9. The method of claim 1 wherein the instructing includes invoking the target application a single time in response to receiving the iterate indicator.

10. The method of claim 1 wherein receiving the iterate indicator further comprises setting a mode of operation to activate a repeat mode.

11. The method of claim 10 wherein the instructing the target application is performed in response to detecting a selection indicator for selecting the first object presented by the target application as not selected.

12. The method of claim 10 further comprises:
detecting a selection indicator for selecting an object in a second plurality of objects, wherein a second target application is configured to present the second plurality of objects on a display; and
instructing, in response to detecting the selection indicator and said setting the mode of operation to repeat mode, the second target application to automatically sequentially present each object in the second plurality as selected.

13. The method of claim 10 wherein the instructing the target application is additionally performed in response to detecting the presentation of the first object on the display by the target application.

14. The method of claim 10 further comprises:
detecting a presentation of a second first object included in a second plurality of objects by a second target application on a display device; and
instructing, in response to detecting the presentation of the second first object and said setting the mode of operation to repeat mode, the second target application to automatically sequentially present each object in the second plurality as selected.

15. The method of claim 10 further comprising:
receiving an end repeat mode indicator; and
setting the mode of operation to end the repeat mode.

16. The method of claim 15 wherein receiving the end repeat mode indicator includes receiving the end repeat mode indicator based on a user input detected by an input device, an expiration of a timer, a detecting of a specified time, a change in state of at least one of the plurality of applications, and a message received via a network.

17. A method for automatically selecting objects in a plurality of objects, the method comprising:
receiving, based on a user input detected by an input device, an iterate indicator for automatically iterating through a plurality of objects;
determining a target application, wherein the target application is configured to present the plurality of objects on a display device; and
in response to receiving the iterate indicator, instructing the target application to automatically present sequentially in time each object, in the plurality, as selected.

18. A system for automatically selecting objects in a plurality of objects, the system comprising:
an execution environment including an instruction processing machine configured to process an instruction included in at least one of an input router component, an application manager component, and an iterator component;
the input router component configured for receiving, based on a user input detected by an input device, an iterate indicator for automatically iterating through a plurality of objects;
the application manager component configured for determining a target application, wherein the target application is configured to present a plurality of objects on a display device;
the iterator component configured for in response to receiving the iterate indicator, instructing the target application to automatically
present, on the display device, a first object, in the plurality, as selected;
update the display device to indicate the first object is not selected after presenting the first object as selected; and
present on the display device, subsequent to presenting the first object as selected, a second object, in the plurality as selected.

19. A system for automatically selecting objects in a plurality of objects, the system comprising:
an execution environment including an instruction processing machine configured to process an instruction included in at least one of an input router component, an application manager component, and an iterator component;
the input router component configured for receiving, based on a user input detected by an input device, an iterate indicator for automatically iterating through a plurality of objects;
the application manager component configured for determining a target application, wherein the target application is configured to present the plurality of objects on a display device; and
the iterator component configured for in response to receiving the iterate indicator, instructing the target application to automatically present sequentially in time each object, in the plurality, as selected.

20. A computer readable medium embodying a computer program, executable by a machine, for automatically selecting objects in a plurality of objects, the computer program comprising executable instructions for:
receiving, based on a user input detected by an input device, an iterate indicator for automatically iterating through a plurality of objects;
determining a target application, wherein the target application is configured to present a plurality of objects on a display device;
in response to receiving the iterate indicator, instructing the target application to automatically
present, on the display device, a first object, in the plurality, as selected;
update the display device to indicate the first object is not selected after presenting the first object as selected; and
present on the display device, subsequent to presenting the first object as selected, a second object, in the plurality as selected.

21. A computer readable medium embodying a computer program, executable by a machine, for automatically selecting objects in a plurality of objects, the computer program comprising executable instructions for:
receiving, based on a user input detected by an input device, an iterate indicator for automatically iterating through a plurality of objects;
determining a target application, wherein the target application is configured to present the plurality of objects on a display device; and
in response to receiving the iterate indicator, instructing the target application to automatically present sequentially in time each object, in the plurality, as selected.
